(19) United States
(12) Patent Application Publication
(10) Pub. No.: US 2015/0018729 A1
(43) Pub. Date: Jan. 15, 2015

(54) THERAPY DEVICE

(71) Applicant: Astrium GmbH, Taufkirchen (DE)

(72) Inventors: Ulrich Kuebler, Markdorf (DE); Peter Kern, Salem (DE); Albert Gollhofer, Stegen (DE)

(21) Appl. No.: 14/378,377

(22) PCT Filed: Feb. 15, 2013
(86) PCT No.: PCT/EP2013/053070

§ 371 Date: Aug. 13, 2014

(30) Foreign Application Priority Data
Feb. 21, 2012 (EP) 12001148.1

(51) Int. Cl. A61H 23/00

(52) U.S. Cl. CPC A61H 23/00; A61H 2201/0165
USPC 601/90

(57) ABSTRACT

A therapy arrangement comprising a platform capable of oscillating, wherein a computer for actuating the platform capable of oscillating is present, wherein a device for capturing the movements of a test person on the platform capable of oscillating and for converting the captured movements into a first control signal for the computer connected to the device is present, and wherein a first element connected to the computer is present for converting a second control signal of the computer into mechanical deflections of the platform capable of oscillating.

The invention relates to a therapy device in accordance with the features of patent claim 1.

The patent document DE 195 07 927 C2 has disclosed a platform capable of oscillating, which consists of a stationary lower part and a movable upper part and which can oscillate substantially in a horizontal plane. Such platforms capable of oscillating are used in medical therapy, in particular for posture training.

Sensorimotor training is a known method for treating traumatic, disease-related or age-related balance disorders. Herein, the person to be treated is required, by deliberately creating an unstable standing ground, to shift the center of gravity of his body using compensating movements in order to prevent, in an extreme case, a fall. Injuries related to falls are by far the leading type of injury in terms of therapy costs or care costs, especially in old age. In the case of sports injuries as well as diseases of the human balancing apparatus, suitable exercises are used to achieve an improvement in the performance capacity or quality-of-life by training other physiological (substitutional) mechanisms. One of the factors for the training is to influence the subconscious, i.e. to prevent a conscious, intentional intervention for finding balance. Only in this way is a person able to avoid accidents in daily life by means of spontaneous compensation reactions to unexpected events (unnoticed ground unevenness or the like).

These days, exercises with the aforementioned background are already carried out. To this end, simple balancing platforms (rockers, cones, foam bases) and complicated structures, e.g. with a gimbal spring suspension, are already used these days. However, what is common to all is that it is necessary to actively distract the person to be treated for training the subconscious; for example by conversation up to solving calculations, etc. This is especially important if the cerebral capability for processing the stimuli or commands to the movement apparatus is responsible for the problems.

DE 601 33 286 T2 has disclosed a balancing trainer in which the movement is captured by sensing elements and transmitted to an electronic interface, which converts the current position of the test person into mouse, joystick or similar pointer-device signals, which are then fed to a personal computer (PC). Thus, a test person can control different application programs running on the PC by voluntary modification of the body posture.

It is an object of the invention to specify a therapy arrangement with a platform capable of oscillating, by means of which the effectiveness of a posture training unit can be increased.

The object is achieved by the therapy arrangement in accordance with the features of current patent claim 1. Advantageous embodiments of the invention are the subject matter of dependent claims.

The therapy arrangement according to the invention comprises a platform capable of oscillating. The invention is distinguished by virtue of a computer being present for actuating the platform capable of oscillating. According to the invention, the therapy arrangement furthermore comprises a device, which captures the movements of a test person on the platform capable of oscillating and converts these into a first control signal for a computer connected to the movement capturing device. According to the invention, a first element connected to the computer is present and converts a second control signal of the computer into mechanical deflections of the movable upper part. By way of example, this first element can be an active element which brings about a deflection of the platform capable of oscillating in a suitable manner.

Expediently, a second element connected to the computer is present. By way of example, this second element can be a damping element which brings about a damping of the platform capable of oscillating in a suitable manner. The computer expediently evaluates the balancing behavior of the patient transmitted by means of the first control signal and adapts the damping to the training state. In the process, the computer expediently generates a third control signal, which is transmitted to the second element.

It was found that the effectiveness of the training can be increased by the interaction of the existing training approaches with devices for computer-assisted balancing exercises. Moreover, the time-intensive use of a therapy staff can be reduced.

The concept of the invention lies in the combination of a platform for posture training with a computer which is suitable for executing application programs. By way of example, the Posturomed® product by Haider may be used as a platform for posture training. Any commercially available games console may be used as a computer.

Both the application of a games console and the application of a posture platform lead to a conscious control. However, the combination of the two installations leads to subconscious finding of balance, i.e. a conscious, wanted intervention for finding the balance is prevented. This effect can even be amplified by the reaction to interference introduced from an external source, or the level of difficulty can be adapted and hence the training intensity can be increased.

In a first embodiment of the invention, the movement capturing device is a balance board for a games console. In this embodiment, the balance board serves as a standing area for the test person. Commercially available balance boards for games consoles comprise a plurality of sensors by means of which the movements of the test persons on the balance board are captured and converted into electrical control signals for transmission to the games console.

In the second embodiment of the invention, the movement capturing device is a visual movement identification apparatus for a games console. In this embodiment, the test person stands in front of the visual movement identification apparatus. Commercially available visual movement identification apparatuses for games consoles conventionally comprise a camera, by means of which the movements of a test person are captured and converted into electrical control signals for transmission to the games console.

In the following text, the invention will be explained in more detail on the basis of figures. In detail:

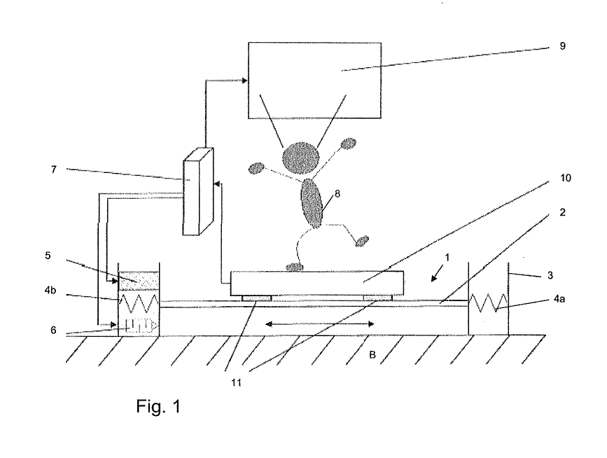

FIG. 1 shows a first embodiment of a therapy arrangement according to the invention, comprising a first exemplary embodiment of a platform capable of oscillating,

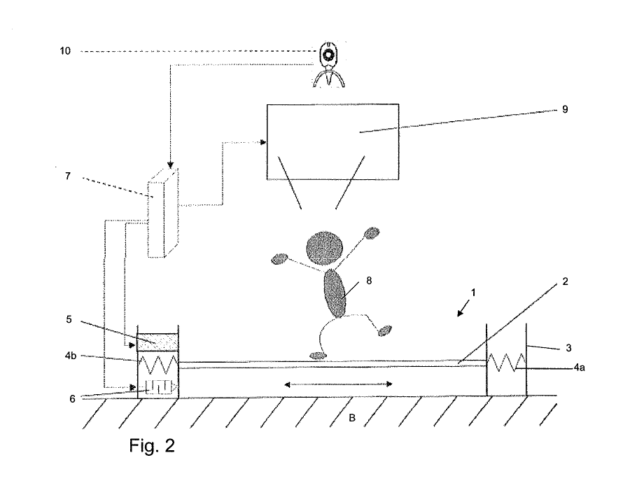

FIG. 2 shows a second embodiment, of a therapy arrangement according to the invention, comprising a first exemplary embodiment of a platform capable of oscillating,

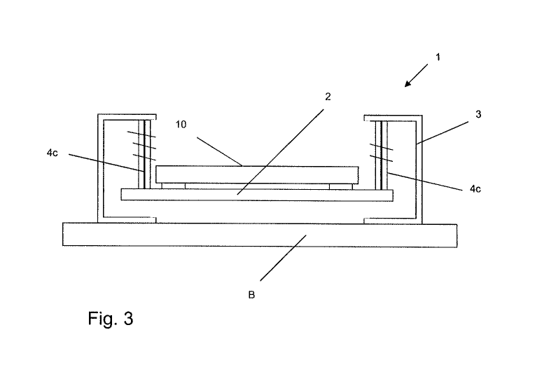

FIG. 3 shows a second exemplary embodiment of a platform capable of oscillating, and

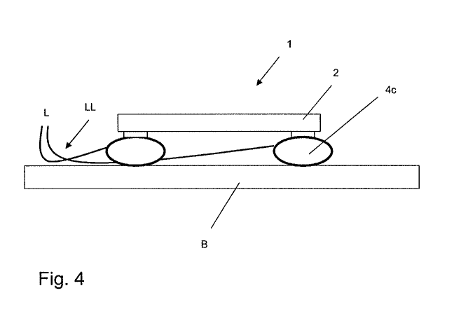

FIG. 4 shows a third exemplary embodiment of a platform capable of oscillating.

FIG. 1 and FIG. 2 show a therapy arrangement comprising a platform capable of oscillating. In an exemplary manner, the platform 1 capable of oscillating comprises a lower part 3 standing on the floor B and an upper part 2 which can move relative to the floor B. Herein the platform 1 can be supported in various ways, such that it is capable of oscillating. In FIG. 1 and FIG. 2, the upper part 2 and the lower part 3 are connected to one another in an exemplary manner by two oscillation elements 4a, 4b. Other variants for supporting the platform such that it is capable of oscillating are known from DB 19507927 C2 or are shown in an exemplary manner in FIGS. 3 and 4. In the embodiments depicted in FIG. 1 and FIG. 2, an active element 5 and a damping element 6 are moreover arranged between the upper part 2 and the lower part 3. The active element 5, e.g. an electric drive or a hydraulic actuator, and the damping element 6, e.g. a pneumatic or electroviscous damper, are respectively connected to a computer 7, e.g. a games console. Application programs which can be displayed to a test person 8 on a screen 9 can be executed on the games console 7.

The test person 8 follows the visual stimuli displayed on the screen 9. The stimuli are represented by an exercise (e.g. by a game, questions, problems, etc.). The use of game-like exercises (e.g. from adapted, commercial PC or console games) can significantly increase the implementation motivation and therefore the effectiveness. The movements are captured in the movement capturing device 10, converted into a first electrical control signal and transmitted to the games console 7. Depending on the first control signal, the games console 7 generates a second control signal and thereby actuates the platform 1 capable of oscillating by the active element 5, in order, e.g., to bring about a deflection of the upper part 2 of the platform 1 capable of oscillating in the direction of the arrow, depending on the respective PC or console game.

The games console 7 additionally generates a third control signal, depending on e.g. the first control signal or on the progress of the application program executed on the games console, and thereby actuates the damping element 6. As a result, it is possible to actively influence e.g. the damping behavior of the platform 1 capable of oscillating as a function of the level of the game or the progress of the therapy. Thus, e.g. the damping can be increased for beginners, while the damping can be reduced in the case of experts (or in an advanced game level). Moreover, permanently analyzing the variability of the center of gravity of the body renders it possible to dynamically regulate the damping. Moreover, events which are displayed on the screen can be simulated on the platform 1 capable of oscillating (e.g. tilting movement, sideward movement when evading an obstacle). Additionally, interference can be applied without visual warning.

In the first embodiment depicted in FIG. 1, the training person 8 stands on a movement capturing device 10, wherein the movement capturing device 10 is fastened to the upper part 2 of the platform 1.

The movement capturing device 10, which is a type of input device for movements, may be an electronic balance board with internal or external sensors 11. The movement capturing device 10 is connected to the games console 7, expediently by means of an appropriate interface (not depicted here). The sensors 11 of the movement capturing device 10 capture the displacement of the body weight of the test person 8 and convert it into electrical signals for transmission to the games console 7.

In the second embodiment, which is depicted in FIG. 2, the training person 8 stands on the platform 1 capable of oscillating in front of a movement capturing device 10. The movement capturing device 10 is a visual movement identification device, e.g. a camera. This device 10 captures the movements of the test person 8 standing on the platform 1 capable of oscillating, converts them into electrical signals and transmits them to the games console 7.

As shown in FIGS. 3 and 4, the oscillation elements 4a, 4b, the active element 5 and the damping element 6 may be replaced by a combination of oscillation and damping elements in a further embodiment of the platform capable of oscillating. FIG. 3 shows that shape alloy elements 4c made of adjustable resilient materials are arranged between the lower part 3 standing on the floor B and the oscillating upper part 2. A movement capturing device 10 situated on the upper part 2 is not depicted here. The shape alloy elements 4c can be actuated by a computer 7 (not depicted here), as depicted in FIGS. 1 and 2.

FIG. 4 shows a further variant, in which adjustable pneumatic actuators 4d are arranged between the floor B and the oscillating upper part 2. By way of example, these pneumatic actuators can be fluid muscles in cushion form. By means of the lines LL, it is possible to pump e.g. air L into the cushions 4d. Expediently, the cushions can be filled with different volumes. As a result, it is possible for the platform 1 capable of oscillating to assume a corresponding pitch with respect to the floor B. The pneumatic actuators 4d can be actuated by a computer 7 (not depicted here) by means of a second or third control signal, as explained in FIGS. 1 and 2.

It is also possible for the shape alloy elements 4c in FIG. 3 to be replaced by e.g. fluid muscles in tube form, which can be filled and actuated according to the same principle as described in FIG. 4.

1. A therapy arrangement with a platform capable of oscillating, comprising:
a computer for actuating the platform capable of oscillating, on which application programs can be executed,
a device for capturing the movements of a test person on the platform capable of oscillating and for converting the captured movements into a first control signal for the computer connected to the device
a first element connected to the computer, for converting a second control signal of the computer into mechanical deflections of the platform capable of oscillating, and
a second element connected to the computer, for converting a third control signal of the computer into a damping of the deflection of the platform capable of oscillating, which third control signal has been generated as a function of the first control signal and/or of a progress of an application program executed on the computer.

2. The therapy arrangement as claimed in claim 1, wherein the movement capturing device is a balance board for an electronic games console, the balance board comprising a plurality of sensors by means of which the movements of the test person on the balance board are captured and converted into electrical control signals for transmission to the computer.

3. The therapy arrangement as claimed in claim 1, wherein the movement capturing device is a visual movement identification apparatus, e.g. a camera for a games console.

4. The therapy arrangement as claimed in claim 1, wherein the first element is an electric drive or a hydraulic actuator.

5. The therapy arrangement as claimed in claim 1, wherein the first element is a combination of an oscillation element and damping element.

6. The therapy arrangement as claimed in claim 5, wherein the first element is embodied as a shape alloy element made of adjustable resilient materials.

7. The therapy arrangement as claimed in claim 5, wherein the first element is embodied as a fluid muscle in cushion form.

8. The therapy arrangement as claimed in claim 7, further comprising lines through which the air can be pumped into fluid muscles in cushion form.

9. The therapy arrangement as claimed in claim 8, further comprising at least two fluid muscles in cushion form, which are provided to be filled with different volumes in order to set a pitch between the platform capable of oscillating and a floor.

10. The therapy arrangement as claimed in claim 2, wherein the first element is an electric drive or a hydraulic actuator.

11. The therapy arrangement as claimed in claim 3, wherein the first element is an electric drive or a hydraulic actuator.

12. The therapy arrangement as claimed in claim 2, wherein the first element is a combination of an oscillation element and damping element.

13. The therapy arrangement as claimed in claim 3, wherein the first element is a combination of an oscillation element and damping element.
